(19) United States
(12) Patent Application Publication
(10) Pub. No.: US 2017/0308954 A1
(43) Pub. Date: Oct. 26, 2017

(54) AN INTERACTIVE OPTIONS TRADING GRAPHICAL USER INTERFACE AND A SYSTEM FOR THE GENERATION THEREOF

(71) Applicant: ENHANCE YOUR OPTIONS PTY LTD, PARKINSON (AU)

(72) Inventor: PAUL MCLAREN, SYDNEY (AU)

(21) Appl. No.: 15/518,458

(22) PCT Filed: Aug. 26, 2016
(86) PCT No.: PCT/AU2016/050804

§ 371 Date: Apr. 11, 2017

(30) Foreign Application Priority Data
Aug. 27, 2015 (AU) 2015903465

(51) Int. Cl. G06Q 40/04; G06F 3/0482; G06T 11/20

(52) U.S. Cl. CPC G06Q 40/04; G06T 11/206; G06F 3/0482; G06F 2203/04806

(57) ABSTRACT

There is provided a system for generating an interactive options trading graphical user interface. The graphical user interface comprises: an asset price graph having an asset price axis and a time axis showing an asset price characteristic over time, the asset price graph dynamically generated using historical financial information data; and an options payoff diagram at an expiry date, the options payoff diagram displayed adjacent to the asset price graph, wherein the options payoff diagram has: an asset price axis parallel and aligned with the asset price axis of the asset price graph; a profitability outcome axis parallel to the time axis of the asset price graph; and a date/breakeven line aligned with the expiry date on the time axis of the asset price graph

### FIELD OF THE INVENTION

The present invention relates to options trading systems and in particular, but not necessarily entirely, to options trading graphical representation and a system for generating an interactive options trading graphical user interface

### BACKGROUND OF THE INVENTION

FreeStockCharts.com Workbook, March 2010, [Retrieved from internet on 1 Jul. 2016]

<URL:http://web.archive.ordweb/20140707100113/http://www.freestockcharts.com/Education?> published 7 Jul. 2014 as per Wayback Machine, [hereinafter referred to as D1] discloses tutorial videos and a PDF workbook relating to FreeStockCharts™. D1 includes a QuickTour and exercises to watch to learn to organize watchlists, customize charts, use the drawing tools and sort with Volume Buzz™. The PDF workbook shows how to apply real-world concepts with step-by-step exercises.

OptionsHouse, Mobile Trading, OptionsHouse for iPad, [Retrieved from internet on 4 Jul. 2016]

<URL:http://web.archive.org/web/20150315163036/http://www.optionshouse.com/technology/mobile/ipad/> published 15 Mar. 2015 as per Wayback Machine [hereinafter referred to as D2] discloses the OptionsHouse™ trading interface called for iPad providing interactive charts, customised layouts to view up to four screens at once, streaming real-time quotes, the ability to create, update or cancel orders, the ability to access and create watch lists, the ability to easily monitor and update positions and the ability to obtain real-time account balances.

The present invention seeks to provide an interactive options trading graphical user interface, a system for generation thereof and a graphical representation thereof, which will overcome or substantially ameliorate at least some of the deficiencies of the prior art, or to at least provide an alternative.

### SUMMARY OF THE DISCLOSURE

There is provided herein an interactive options trading graphical user interface, a system for generation thereof and a graphical representation thereof.

As will become apparent from the ensuing description, the options trading graphical user interface is more than of intellectual character in that it provides a material advantage (in the sense of a practical utility) making option trading outcomes visually comprehendible to the trader allowing for enhanced decision making and therefore facilitating better trades.

Now, by way of contradistinction, prior art trading interfaces may comprise options payoff diagrams and asset price graphs. However, such prior art interfaces suffer from the disadvantage in that these graphs are separate and therefore incongruent and it is difficult for the trader to visually reconcile the information presented by each.

Specifically, the asset price at expiry is crucial to a successful options strategy, and the resulting profit and loss, but the foregoing information available to options traders provides no indication of the likelihood of a price being achieved, nor any way to marry the two displays together.

The prior art trading interfaces as described above includes the displaying of different charts depicting various information, by placing charts side by side in a mosaic or tile pattern. As such, the prior art does not allow for the displaying of an options payoff diagram in any orientation overlaid directly onto a historical price chart. As will be appreciated from the ensuing description, the information offered in embodiments provided herein by the two charts, the profitability of a particular options strategy (derived from the Payoff Diagram) and the probability of a price being obtained (derived from the historical price chart and associated technical indicators) in a single, aligned view, provides unique, valuable information to the user not previously provided for.

The claimed invention is designed to provide material advantages in the sense of a practical utility of the trading interface which allows the trader to facilitate better trading by utilising enhanced data visualization.

Specifically, the claimed invention provides the practical utility of a quick visual indication of the likelihood of the trade being successful, by gauging whether the spot price at expiry is likely to be within the range necessary for a profitable trade.

Specifically, and as will be described in further detail below, the options trading graphical user interface comprises a payoff diagram which is characterised in that it is rotated and reflected as compared to conventional payoff diagrams and has an asset price axis aligned with an asset price axis of an adjacently displayed historical asset price graph and has a date/breakeven line aligned with a time axis of the adjacently displayed historical asset price graph.

In this way, the interface provides a material advantage in allowing the trader the practical utility of visually gauging the expected profitability of a selected options strategy at the future expiry date by visually gauging the momentum of the underlying asset offset from the date/breakeven line.

Furthermore, in embodiments, the options trading graphical user interface further comprises a volume-at-price graph displayed adjacently the payoff diagram and having a coincident asset price axis.

In this manner, the options trading graphical user interface further provides a material advantage in that it allows for the visual comprehension of the probability of expected asset price at the future expiry date.

In further embodiments, the system or the trader may optimise the expected monetary value of an options strategy which may include a number of options in combination. In this regard, the outcome of the optimised trading strategy is displayed by the payoff diagram adjacent the asset price probability as indicated by the volume-at-price diagram.

As such, the interface further provides a material advantage in allowing the trader to visually inspect the optimisation of the optimised options strategy in accordance with the coincidence of the profitable outcomes (being to the right of the breakeven line) of the payoff diagram coinciding substantially with the probability maxima indicated by the volume-at-price diagram.

In other words, the trader is able to visually comprehend whether the options strategy has been optimised property by visually inspecting whether the payoff diagram represents a substantial mirror image of the probabilities indicated by the volume-at-price diagram.

As such, various embodiments of the options trading graphical user interface provided herein provide material advantages in:
a. allowing for the visual comprehension of the profitability of an option strategy by allowing the trader to visually estimate the asset price at expiry date using the visually apparent historical momentum of the asset price of the underlying instrument;
b. allowing for the visual comprehensive of the probability of an expected asset price at the expiry date; and
c. visually ascertaining the optimising of an optimised trading strategy.

As such, with the foregoing in mind,

According to a first aspect, there is provided a system for generating an interactive options trading graphical user interface, the graphical user interface comprising: a processor for processing digital data; a memory device for storing digital data including computer program code, the computer program code comprising a plurality of software modules, the memory device being in operable with the processor and wherein the plurality of software modules comprises: a graphical user interface rendering module comprising: a rotated payoff diagram rendering module for rendering a options payoff diagrams; and an asset price graph rendering module for rendering an asset price graph; a network interface for receiving data across a data network including historical financial information data from a historical financial information database; a display device for display in the options trading graphical user interface wherein the options trading graphical user interface comprises: the asset price graph having an asset price axis and a time axis showing an asset price characteristic over time, the asset price graph dynamically generated using the historical financial information data; and an options payoff diagram at an expiry date, the options payoff diagram displayed adjacent to the asset price graph, wherein the options payoff diagram has: an asset price axis parallel and corresponding to the asset price axis of the asset price graph; a profitability outcome axis parallel to the time axis of the asset price graph; and a date/breakeven line aligned with the expiry date on the time axis of the asset price graph.

The graphical user interface may further comprise: a further payoff diagram at a selected date, the further options payoff diagram displayed adjacent to the asset price graph, wherein the further options payoff diagram may have: an asset price axis parallel and corresponding to the asset price axis of the asset price graph; a profitability outcome axis parallel to the time axis of the asset price graph; and a date/breakeven line aligned with the selected date on the time axis of the asset price graph.

The date/breakeven line of the further payoff diagram may be interactively positionable to adjust the selected date.

The further payoff diagram may dynamically update in accordance with a selected date adjustment.

The options trading graphical user interface may further comprise an interactive strike price line interactively positionable to adjust a strike price and wherein the options payoff diagram dynamically updates in accordance with a strike price adjustment from the interactive strike price line.

Option values may be displayed adjacent the interactive strike price line and wherein adjusting the position of the interactive strike price line may cause the option values to dynamically update accordingly.

The options payoff diagram may display an option strategy comprising a plurality of options and wherein the options trading graphical user interface may comprises a plurality of interactive strike price lines interactively positionable to adjust a strike price for each of the plurality of options.

Option values may be displayed adjacent each of the plurality of interactive strike price lines.

The options trading graphical user interface may further comprise an interactive target price line interactively positionable to adjust a target price and wherein the further options payoff diagram dynamically updates in accordance with a target price adjustment.

The options trading graphical user interface may further comprise an implied volatility input and wherein the further payoff diagram dynamically updates in accordance with an implied volatility adjustment.

The options trading graphical user interface may further comprise a selected strategy key statistics window displaying selected strategy key statistics and wherein the selected key statistics may be configured to dynamically update in accordance with at least one of a strike price adjustment and expiry date adjustment.

The options trading graphical user interface may further comprise an options leg strategy information window displaying options leg strategy information and wherein the options leg strategy information may be configured to dynamically update in accordance with at least one of a strike price adjustment, target price adjustment, selected date adjustment and expiry date adjustment.

The options trading graphical user interface may further comprise a volume-at-price diagram having an asset price axis parallel and corresponding to the asset price axis of the options payoff diagram, the volume-at-price diagram having a volume-at-price axis.

The asset price graph may be displayed in accordance with an adjustable date range and wherein the volume-at-price chart updates dynamically in accordance with a date range adjustment of the asset price graph.

The plurality of software modules may further comprise an expected monetary value calculation module configured for calculating an expected monetary value in accordance with a probability distribution function derived from volume-at-price chart data and possible financial outcomes data derived from the options payoff diagram at an expiry date and wherein the options trading graphical user interface displays the expected monetary value and wherein the expected monetary value dynamically updates in accordance with the date range adjustment of the asset price graph

The software modules further comprise an option strategy optimisation module configured for optimising an optimised option strategy and wherein the options payoff diagram displays the optimised option strategy adjacent the volume-at-price diagram.

In accordance with another aspect, there is provided printed matter comprising an options trading graphical representation comprising: asset price graph having an asset price axis and a time axis showing an asset price characteristic over time; and an options payoff diagram at an expiry date, the options payoff diagram displayed adjacent to the asset price graph, wherein the options payoff diagram has: an asset price axis parallel and corresponding to the asset price axis of the asset price graph; a profitability outcome axis parallel to the time axis of the asset price graph; and a date/breakeven line aligned with the expiry date on the time axis.

The printed matter may further comprise a further payoff diagram at a selected date, the further options payoff diagram displayed adjacent to the asset price graph, wherein the further options payoff diagram may have: an asset price axis parallel and corresponding to the asset price axis of the asset price graph; a profitability outcome axis parallel to the time axis of the asset price graph; and a date/breakeven line aligned with the selected date on the time axis of the asset price graph.

The printed matter may further comprise a volume-at-price diagram having an asset price axis parallel and corresponding to the asset price axis of the options payoff diagram, the volume-at-price diagram having a volume-at-price axis.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows system for generating an interactive options trading graphical user interface;

FIG. 2 shows a transformation from a conventional payoff diagram to that which is disclosed herein in accordance with an embodiment of the present disclosure;

FIG. 3 shows an exemplary options trading graphical user interface in accordance with an embodiment of the present disclosure;

FIG. 4 shows the total visual output for a selected Long Underlying strategy in accordance with an embodiment of the present disclosure;

FIG. 5 shows the payoff diagrams for a selected Long Underlying strategy in accordance with an embodiment of the present disclosure;

FIG. 6 shows the selection of the Covered Call Strategy from the Option Strategy field of the Parameters pane in accordance with an embodiment of the present disclosure;

FIG. 7 shows the visual output for a selected Covered Call Strategy in accordance with an embodiment of the present disclosure;

FIG. 8 shows the visual output for a selected Covered Call Strategy, after the adjustment of the price received for the Call Option in accordance with an embodiment of the present disclosure;

FIG. 9 shows the payoff diagrams for a selected Covered Call Strategy in accordance with an embodiment of the present disclosure; and

FIG. 10 shows the payoff diagrams for a selected Covered Call Strategy.

### DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to the system for generating an interactive options trading graphical user interface are disclosed and described, it is to be understood that this disclosure is not limited to the particular configurations and process steps and such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

### Options Trading

An option is a financial derivative that represents a contract sold by one party (option writer or seller) to another party (option holder or buyer). The contract offers the buyer the right, but not the obligation, to buy (call) or sell (put) a security or other financial asset at an agreed-upon price (the strike price or exercise price) during a certain period of time or on a specific date (expiry or exercise date).

Call options give the option to buy at certain price. Put options give the option to sell at a certain price.

Options are complex securities and options trading can be extremely risky.

Accordingly, it is imperative that options traders have trading interfaces allowing for the making of informed, sound and split second decisions.

### Rotated and Reflected Payoff Diagram

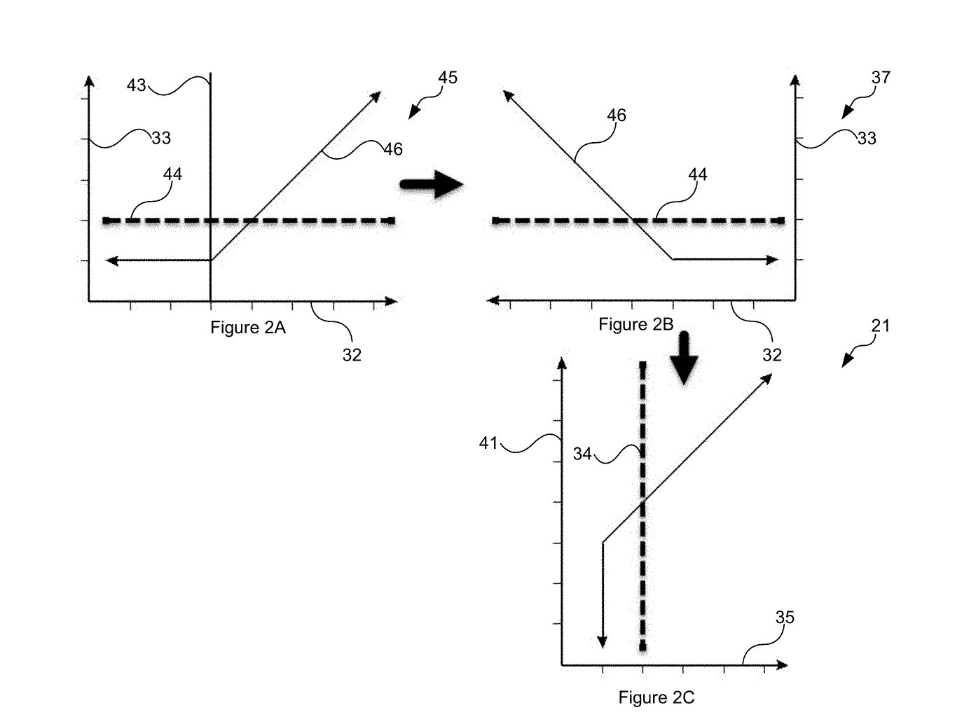

The industry accepted format for displaying options payoff diagrams is shown in FIG. 2A. The options payoff diagram 45 has an asset price x-axis 32 showing the input price of the asset (e.g. share, commodity, index, etc), and a profit or loss y-axis 33 showing the output profit or loss. The options payoff diagram 45 further includes a linear payoff characteristic 46, a vertical exercise/strike price line 43 and a horizontal breakeven line 44.

Now, FIG. 2B and FIG. 2C show the transformations performed on the conventional payoff diagram to that which is utilised herein.

Specifically, FIG. 2B shows the reflection of the payoff diagram along the y-axis, resulting in a reflected payoff diagram 37.

Thereafter, FIG. 2C shows a further rotated payoff diagram 21, rotated clockwise through 90° with respect to the reflected payoff diagram 37.

As can be seen, the reflected and rotated payoff diagram 21 therefore comprises a vertical asset price axis 41 and a horizontal profit or loss axis 35. The date/breakeven point line 34 is now shown vertically.

Such an arrangement advantageously allows for the payoff diagram 21 to be visually congruent with an adjacently displayed asset price graph and, in embodiments, an adjacently displayed volume-at-price graph so as to confer the material advantages alluded to above.

### System

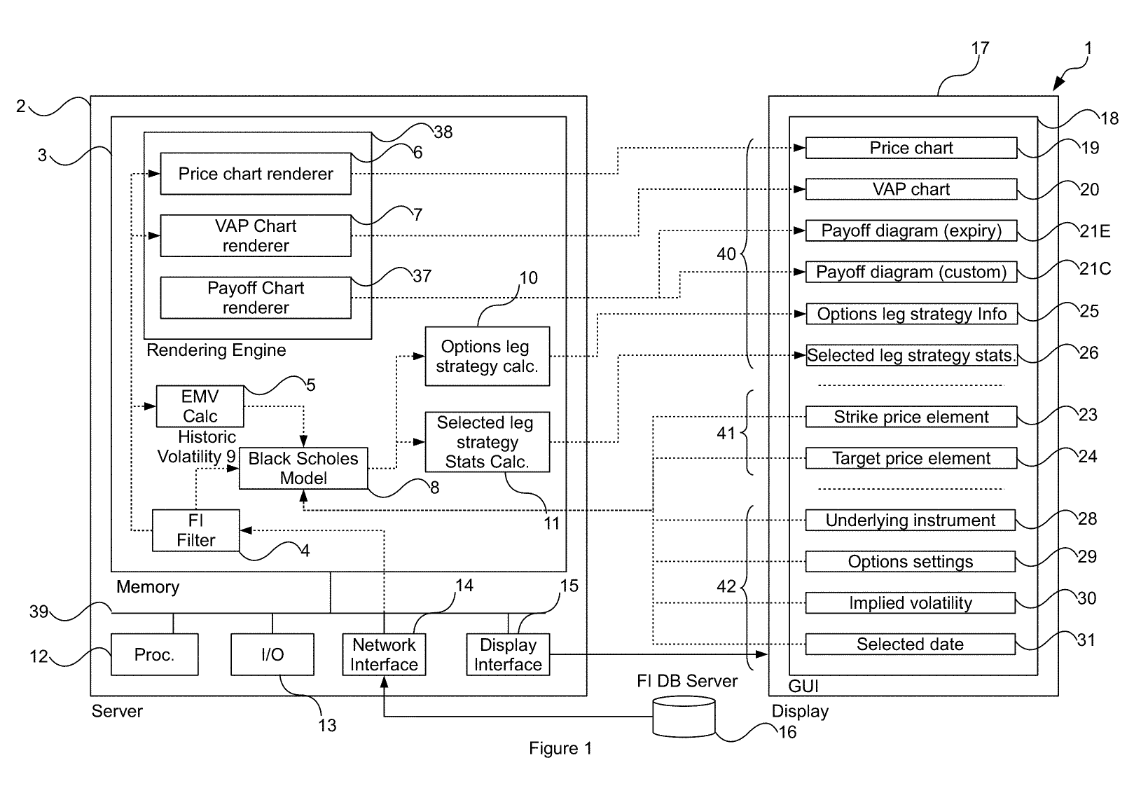

Turning onto FIG. 1, there is shown a system 1 for generating the interactive options trading graphical user interface.

As can be seen, the system 1 comprises a computing device 2 in operable communication with an electronic display device 17. The electronic display device 17 is configured for displaying the interactive options trading graphical user interface 18 in the manner described herein.

In this regard, the computing device 2 comprises a processor 12 for processing digital data. In operable communication with the processor 12 across a system bus 39 is a memory device 3. The memory device is configured for storing digital data, including computer program code.

The memory device 3 may take on differing memory device types including solid-state and disc storage. For example, the memory device 3 may comprise RAM storage and HDD storage.

As such, during the bootstrap phase, the computer program code may be loaded from the HDD storage to the RAM storage for execution by the processor 12.

As can be seen from FIG. 1, the computer program code may comprise a plurality of software modules which will be described in further detail below.

The computer device 2 may further comprise a video interface 15 in operable communication with the processor 12 via the bus 39. The video interface 15 is operably coupled to the display device 17 for the purposes of displaying the graphical user interface 18 in the manner described herein.

The computer device 2 may further comprise an I/O interface 13 configured for interfacing with various computer peripherals. In embodiments, the I/O interface 13 may interface with various graphical user interface devices, such as pointing and keyboard devices. In a manner described herein, the user may interact with the graphical user interface 18 via such graphical user interface computer peripherals.

Furthermore, the computing device 2 may comprise a network interface 14 for sending and receiving digital data across a computer network. In embodiments described herein, the network interface 14 may retrieve historical financial information data from a financial information database server 16. Specifically, as will be described in further detail below, the network interface 14 may be configured for retrieving historical price data of the nominated underlying instrument which may be utilised for the purposes of rendering the graphical user interface 18 in the manner described herein.

It should be noted that the exemplary architecture provided in FIG. 1 is primarily illustrative and that modifications may be made thereto within the purpose of scope of the embodiments described herein. Specifically, for the embodiment provided, the system 1 takes the form of a personal computing device 2 and associated display device 17. However, in other embodiments, the system 1 may take more of a distributed architecture wherein at least a subset of the computational processing may be performed on a centralised physical or virtualised server in operable communication with at least one client terminal.

Furthermore, the computational functionality described here and may be implemented by way of add-on or add-in modules for an existing electronic trading platform.

### Dataflow

Whereas FIG. 1 shows the physical and/or computer componentry connections in solid lines, the logical data flow is provided for illustrative convenience in dotted lines, which dataflow is described in further detail below.

Specifically, the graphical user interface 18 may be divided for convenience into various graphical user interface renders 40, interactive on-screen elements 41 and user configurable parameters 42.

With regards to the renders 40, the graphical user interface 18 is configured for rendering an asset price graph 19 and at least one payoff diagram 21. In a specific embodiment provided herein, the interface 18 is configured for display in a payoff diagram at expiry 21E and a payoff diagram at a user customisable date 21C.

In this regard, the payoff diagram at expiry 21E comprises an expiry date/breakeven point line 34E and the payoff diagram at a custom data 21C comprises a selected date/breakeven point line 34C,

In the embodiments provided herein, the payoff diagram 21 is the payoff diagram characterised in that it is rotated and reflected as compared to conventional payoff diagrams as described above with reference to FIG. 2.

In embodiments, the interface 18 may further comprise a volume-at-price graph 20 render.

Now, for rendering, the software modules may comprise a rendering engine 38. Specifically, as can be seen, the rendering engine 38 may comprise a price chart rendering module 6 to render the price graph 17, a payoff diagram rendering module 37 to render the payoff diagram and a volume at price rendering module 7 to render the volume at price chart 20. Other rendering modules may be included additionally for rendering the additional renders described herein including for rendering the interactive on-screen elements 41.

Yet further, the graphical renders 40 may comprise additional numeric data windows including an options leg strategy information window 25 and a selected key strategy statistics window 26.

Furthermore, and as alluded to above, utilising the interface 18, the trader may configure various parameters utilising the user configurable parameters 42.

Specifically, utilising the editable parameters 42, the trader may select the underlying instruments 28 which may, for example, be any one of shares/stocks, forex, indices, commodities futures and the like. As can be seen, the selected underlying instrument feeds into a financial information filter module 4 which filters or selects historical price data for the nominated underlying instrument from the financial information database server 16 which may then be utilised for the purposes of rendering the price graph 17.

Data retrieved from the financial information filter module 4 may additionally be utilised for other purposes, including determining historical volatility 9.

Utilising the user configurable parameters 42, the trader may additionally configure various options settings 29 including in configuring an options expiry date, options type (such as American or European) and option strategy and more.

The software modules may further comprise a Black Scholes Model module 8 configured to calculate the Theoretical Option Value at any point up to the Expiry Date. The Black Scholes Model module 8 may further be utilised for calculating options leg strategy information 10 which may be displayed by the options leg strategy information window 25 and selected key strategy statistics 11 which may be rendered via the selected key strategy statistics window 26.

As can be seen, the Black Scholes Model module 8 has as input historical asset price data from the financial information filter module 4.

Furthermore, the Black Scholes Model module 8 may further have as input historical volatility 9 which may be ascertained additionally from the historical asset price data retrieved from the financial information filter module 4.

The Black Scholes Model module 8 may further have as input user configurable strike price which may be set by the trader utilising a configurable strike price interactive element 23. Specifically, in embodiments, the trader may drag the strike price interactive elements 23 to configure strike prices for both the payoff diagram at expiry 21E and the payoff diagram at a selected date prior expiry 21C. Adjusting the respective strike prices will cause both of the payoff diagrams 21E and 21C to dynamically update.

Additionally, for the payoff diagram at a selected date 21C, the on-screen interactive elements 41 may further comprise a dragable target price on-screen interactive element 24. Adjusting the target price in such a manner will cause the payoff diagram at a selected date 21C to dynamically update.

Furthermore, utilising the user configurable parameters 42, the trader may additionally use an adjustable implied volatility 30 as opposed to the historical volatility 9 which is, again, fed into the Black Scholes Model module 8.

Furthermore, utilising the user configurable parameters 42, the trader may adjust the selected date 31 of the payoff diagram 21C. In embodiments, the date/breakeven line 34 may be dragged horizontally to adjust the expiry date and the payoff diagram at the selected date 21C dragged horizontally to adjust the selected date.

### Options Trading Graphical User Interface

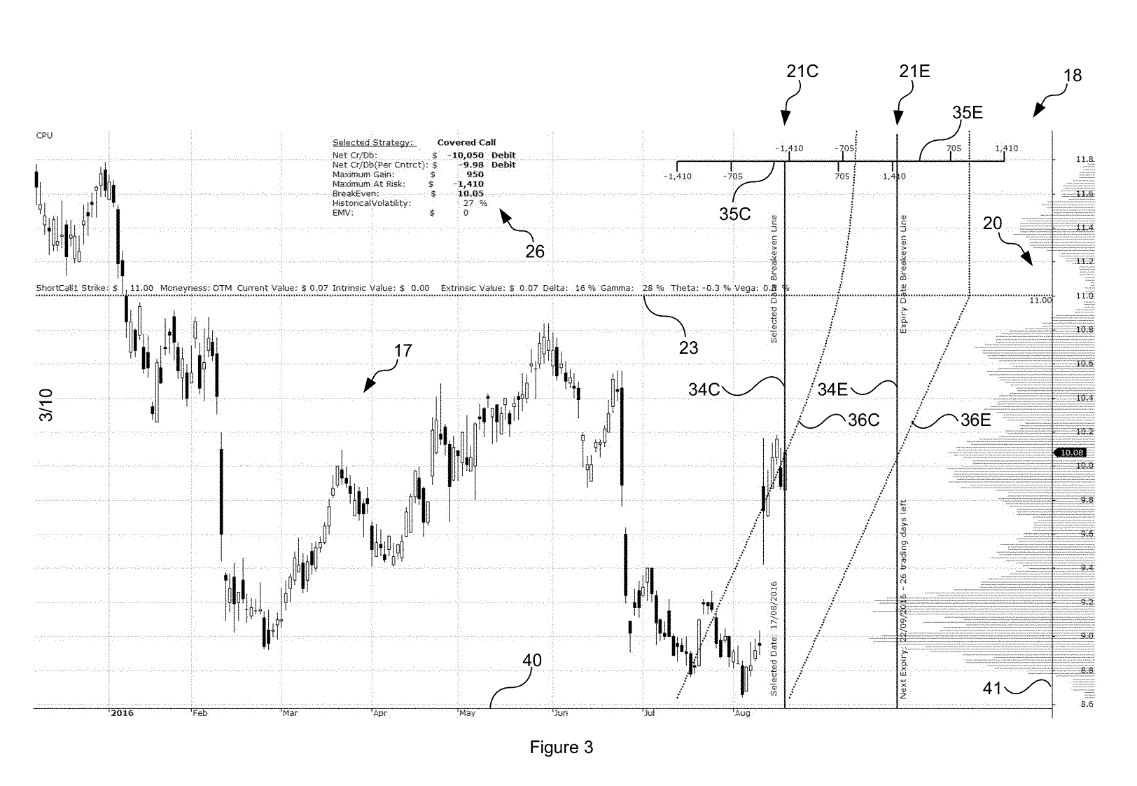

Turning now to FIG. 3, there are shown an exemplary options trading graphical user interface 18.

As alluded to above, in embodiments, the graphical user interface 18 is displayed by the electronic display 17.

The interface 18 comprises the historical price data graph 17 for the underlying instrument. As also alluded to above, the price graph 19 may be rendered by the price chart rendering module 6 which retrieves the historical price data for the relevant underlying financial instrument from the financial information filter module 4.

The asset price graph 17 has a time axis which, in the embodiment shown, spans from December 2015 to August 2016 and beyond. Furthermore, the asset price graph 17 has an asset price axis 41. As such, historical asset price data is displayed by the asset price graph 17.

In the embodiments shown, the asset price graph 17 is displayed in candlestick format showing daily asset price movements wherein, in the embodiment shown, a white candlestick indicates an asset price increase proportionate with the length of the candlestick and a black candlestick correspondingly represents a share price decrease.

Now, the interface 18 further comprises an options payoff diagram 21 displayed adjacent the asset price graph 17.

The options payoff diagram 21 may comprise an options payoff outcome 36 which represents an outcome of a chosen option strategy including a combination thereof at a particular asset price.

The payoff diagram 21 further comprises a date/breakeven point line 34.

The date/breakeven point line 34 coincides with a profitability axis 35 showing the profitability of the option at various asset price outcomes. In this regard, an outcome 36 lying to the right of the date/breakeven point line 34 represents a profitable option strategy and vice versa.

In the embodiment shown in FIG. 3, the exemplary option strategy shown is profitable for an asset price of greater than $10.05.

Furthermore, importantly, the date/breakeven point line 34 is aligned along the time axis of the asset price graph 17. Specifically, the exemplary date/breakeven point line 34 represents that the expiry of the option is 22 Sep. 2016, being 26 trading days from the present, or the most recent asset price data from the asset price graph 17.

### Options Trading Graphical User Interface—Material Advantage in Visually Ascertaining Expected Profitability at Expiry Date

Now, as alluded to above, the alignment of the expiry date of the payoff diagram 21 provides a material advantage in that the profitability of the option strategy may be visually ascertained by the trader.

Specifically, the momentum of the historical asset price data may be visually gauged by the trader to estimate the likely asset price at the expiry date and therefore the likely profitability of the option strategy.

Specifically, in the embodiment shown in FIG. 3, the general trend of the asset price data 17 is downwards. As such, utilising the long-term downwards trend, the trader may visually ascertain that the likely share price at the expiry date of 22 Sep. 2016 may be below $10 and therefore the selected option strategy would be unprofitable given that the options trading outcome 36 lies to the left of the date/breakeven point line 34 at this asset price.

In other words, the momentum of the asset price data may be visually ascertained by the trader across the distance between the most recent asset price data of the asset price graph 17 and the date/breakeven point line 34 of the payoff diagram 31 along the time axis.

In embodiments, an algorithmic pricing momentum indicator graph (not shown) may be overlaid the time axis 40 additionally to further assist the visual gauging of the likely eventual asset price data at expiry.

### Options Trading Graphical User Interface—Adjusting the Selected Date

Now, in the embodiment shown in FIG. 3, there is provided a payoff diagram at expiry 21E.

However, in embodiments, the trader may wish to adjust the calculation date to any selected date prior to expiry (the expiry date).

As such, in the embodiment shown, the interface 18 further comprises a secondary payoff diagram 21C at a selected date. As alluded to above, the selected date for the secondary payoff diagram 21C may be adjusted utilising a parameter input field or by additionally dragging the selected date/breakeven line 34C horizontally.

As can be seen, the secondary payoff diagram 21C may display a payoff outcome 36C at the selected date.

Furthermore, separate profitability axes 35 may be provided for the secondary payoff diagram 21 wherein the profitability axis 21E for the payoff diagram at expiry 21E is shown above the axis line and the profitability axis 21C for the secondary payoff diagram at the selected date 21C is shown beneath the line.

### Options Trading Graphical User Interface—Adjusting Strike Price

As alluded to above, the interface 18 may comprise an on-screen interactive element 41 in the form of a draggable strike price line 23.

Specifically, utilising the mouse pointer or the like, the strike price interactive element 23 may be dragged vertically so as to adjust the strike price of the options settings 29.

Adjusting the strike price will cause the options trading characteristics 36 to update for both the payoff diagrams 21 displayed.

As can be seen, above the strike price line interactive element 23, various relevant information may be provided.

Specifically, the information may comprise the nominated name for the option strategy, given as “ShortCall1” in the embodiment shown.

Furthermore, the value of the strike price is also shown, given as $11.

Furthermore, an indication of the “moneyness” is shown categorised, has been either out of the money, “OTM”, in the money “ITM”, and at the money “ATM”. In the embodiment shown, the moneyness shows out of the money as strike price line 23 is above the last price.

Further information may be displayed such as the current, intrinsic and extrinsic values.

Furthermore, various industry recognised Options Greeks may be displayed.

In embodiments, more than one strike price line interactive element 23 may be provided. For example, for a long call butterfly spread consisting of three legs with a total of four options: long one call with a lower strike, short two calls with a middle strike and long one call of a higher strike, separate strike price line interactive elements 23 may be provided for each option.

### Options Trading Graphical User Interface—Adjusting Target Price

In an embodiment, the interface 18 may further comprise a target price line interactive element (not shown) allowing the trader to utilise a target price for calculation of the statistics displayed as opposed to the most recent asset price.

Adjusting the target price will cause the secondary options payoff diagram at the selected date 21C to dynamically update, the options payoff diagram at expiry 21E remaining unchanged.

### Options Trading Graphical User Interface—Material Advantage in Visually Ascertaining Probability of Expected Asset Price at Expiry

As alluded to above, the interface may further provide a material advantage in allowing the trader to visually ascertain the probability of an estimated asset price at expiry.

Specifically, in this embodiment, the interface 18 further comprises a volume-at-price diagram 20 shown adjacent the asset price graph 17 and the payoff diagram 21.

As can be seen, the volume-at-price diagram 20 comprises an asset price axis coinciding with that of the asset price graph 17 and the payoff diagram 21.

Furthermore, the volume-at-price diagram 20 further comprises a volumetric axis visually representative of the number of shares traded at particular asset prices along the asset price axis.

The volume-at-price diagram 20 may represent the volumes for the time period of the asset price graph 17.

The superimposition of the volume-at-price diagram 20 allows for the estimation of the probability of an estimated asset price at expiry given the historical tendency for the underlying instrument to trade at certain asset prices as opposed to others.

Specifically, for the exemplary underlying instrument shown in FIG. 18, the instrument has probability maximum (i.e. is most likely to trade) in the region of $8.60 and $11.00 and probability minima (i.e. least likely to trade) in the region of approximately $11 and $11.80.

As such, the superimposition of the volume-at-price diagram 20 adjacent the asset price graph 17 allows the trader to not only estimate the asset price at expiry date given the historical momentum of the underlying instrument, but also the probability of such estimate.

For example, were the trader to favour the above-described long-term downwards trend of the underlying asset, the trader may visually estimate that the asset price may eventuate at between $9.10 and $9.50.

However, the superimposition of the adjacent volume-at-price chart 20 would indicate to the trader that the eventual asset price of approximately $9.20 is more probable as opposed to, for example, $9.40.

The probability may be decision-making especially where the share price could eventuate near the asset price coinciding with the date/breakeven point line 34. Specifically, in the embodiment shown in FIG. 18, the volume-at-price diagram 20 represents that a share price of between $9.80 and $10.20 (essentially breakeven) is more likely than share prices above $10.20 (being profitable).

### Options Trading Graphical User Interface—Expected Monetary Value

In embodiments, the options payoff outcome 36 and the volume of price data may be utilised to calculate an expected monetary value (EMV) of an option strategy.

Specifically, as can be seen from FIG. 1, the software modules may comprise an expected monetary value calculator module 6 configured for calculating the expected monetary value of an option strategy.

The expected monetary calculator module 6 utilise the probability distribution function from data that produced the volume-at-price chart 20 and the possible financial outcomes derived from the payoff diagram at expiry 21E, for each price displayed in the current view of the price chart 17 to calculate the expected monetary value.

In embodiments, by zooming in and out of the price chart 17, the volume-at-price chart 20 updates and consequently the expected monetary value updates, providing a user with a gauge of the sensitivity of the selected strategy to various price probability distributions.

The calculation of the expected monetary value (EMV) may feed into the selected key strategy statistics population module 11 which may be displayed via the selected key strategy statistics window 26 displayed in the interface 18.

As such, adjusting the date range of the price chart 17 causes the displayed expected monetary value calculation to update.

### Options Trading Graphical User Interface—Material Advantage in Visually Ascertaining Optimisation Accuracy of Options Trading Strategy

Referring again to FIG. 1, the software modules may comprise an options strategy optimisation module configured to optimise the expected monetary value. Such optimisation may configure various options settings 29 and the combinations of various options types. Alternatively, the trader may manually configure and combine option strategies for such optimisation.

Such optimisation may result in a payoff outcome 36 having complex shapes.

As such, the interface 18 may further confer the additional material advantage in allowing the trader to visually ascertain the optimisation accuracy of an optimised strategy. Specifically, the interface 18 allows for the visual comprehension of whether a particular optimised option strategy is the most probable. In this way, utilising the interface 18, the trader may perform optimisations to arrive at an optimised option strategy that is most probable.

Specifically, the trader should visually inspect the interface 18 for the payoff outcome 36 being a mirror image of the probability as indicated by the volume-at-price diagram 20.

In this manner, the trader would inspect the interface to ensure that the profitable outcomes (being to the right of the date/breakeven point line 34) generally coincide with the most probable eventual share prices at expiry as is indicated by the magnitude of the adjacent volume-at-price diagram 20.

For example, should the trader visually ascertain that the profitable share price ranges are not likely, the trader may continually further optimise the option strategy until such time that the profitable share price ranges or indicated visually has been most probable.

### Exemplary Walk-Through

There will now be described in exemplary walk-through for further illustration of the operation of the system 1 and the material advantages conferred by the configuration of the graphical user interface 18.

It should be noted that these embodiments are exemplary only and that no technical limitations should necessarily be imputed all of the embodiments within the purpose of scope accordingly.

In the embodiment provided herein, a trader wishes to undertake a Covered Call Options strategy trade (Long/Bought Underlying Stock and Short/Sold Call).

The trader enters a Long Underlying (Stock) position by buying 1000 Shares at $10.08.

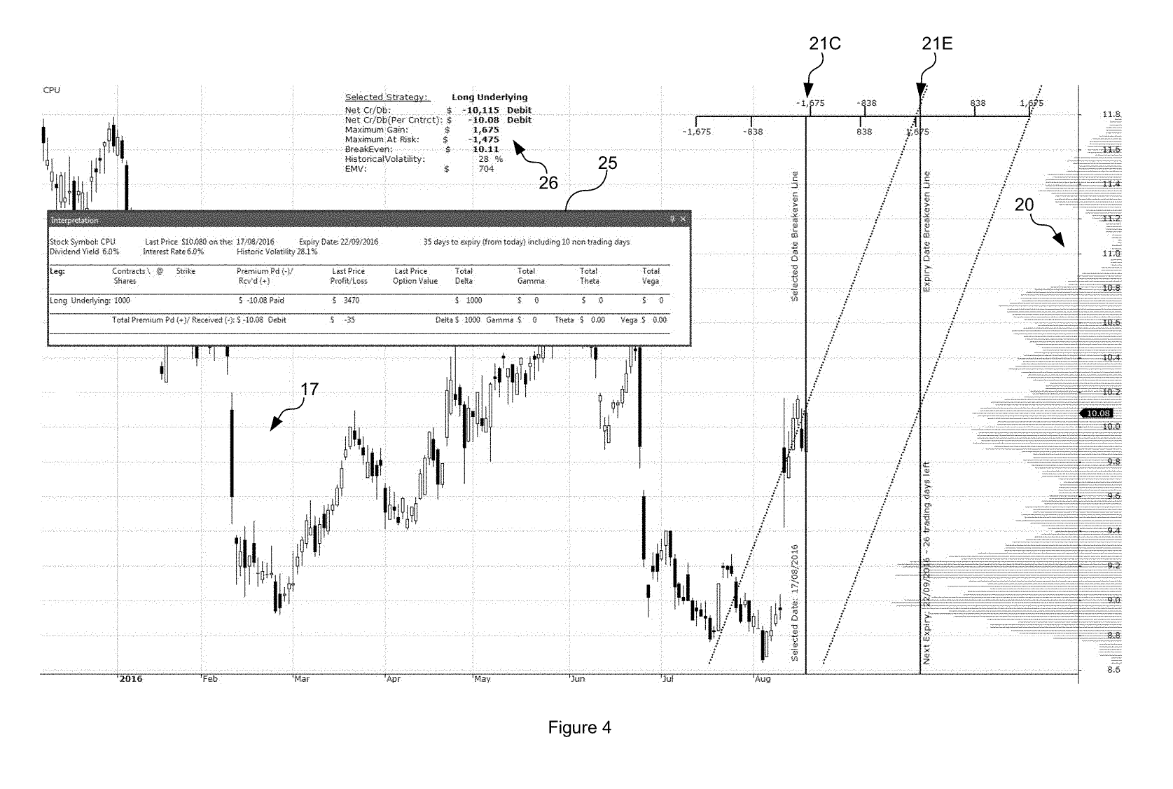

The entry price $10.08 is entered into the system 1 and the following, with reference to FIG. 4 are displayed
a. An Options Payoff Diagram at Expiry 21E.
b. An Options Payoff Diagram at any date up to and including Expiry 21C.
c. The Option Leg Strategy Information 25 (Displayed in a Floating Window that can be displayed/hidden or moved for convenience)
d. The Selected Key Strategy Statistics 26 that are constantly displayed on the top of the graph.

The Selected Key Strategy Statistics of the overall strategy are displayed on the screen.

The trader observes that the Expected Monetary Value of the Strategy is $704.00.

As this is positive, the trader explores further.

The trader compares the possible outcomes of the strategy from the Payoff Diagrams at expiry 21E and the Selected Date 21C, with probability of the strategy being profitable by a quick visual glance of the price required at expiry for the trade to be profitable.

The probability of any price within the current date range view is indicated by the volume-at-price graph 20, which indicates that certain prices are more probable than others. This key information is visually reconciled with the price momentum (trend) of the underlying instrument as indicated by the historical price graph 17. The price momentum of the historical price graph 17 needs to be in the same direction as the zone of a profitable trade, with the timeframe of the trend corresponding to the time frame of the options trade (from the trade entry date to expiry).

The trader wishes to explore the potential probability of a covered call (Long Underlying and Short Call), by selling a call against their Long Underlying position.

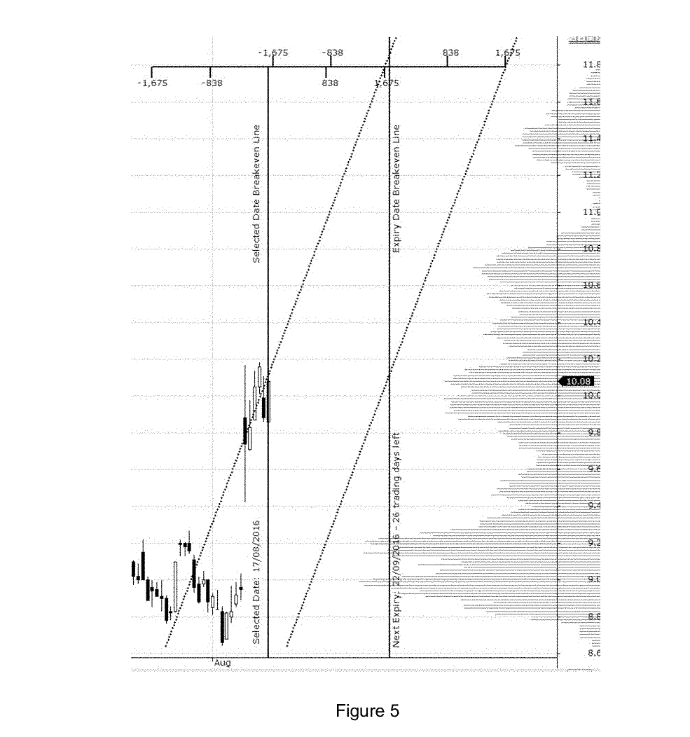

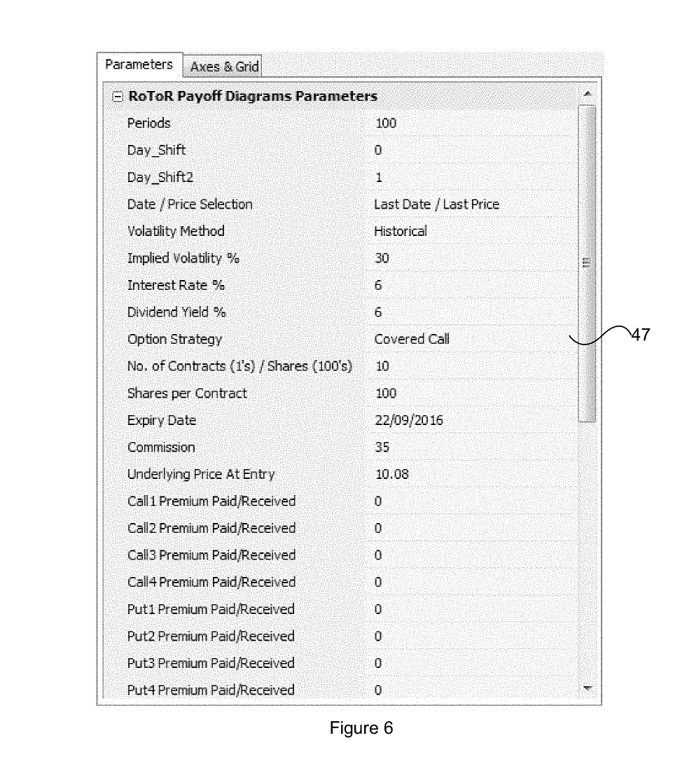

As such, with reference to FIG. 5, showing the payoff diagram for the Long Underlying, the trader selects the Covered Call Strategy 47 from the Option Strategy field of the Parameters pane shown in FIG. 6.

The trader is prompted to draw the strike prices required for the chosen strategy.

The user will be prompted to draw all necessary legs of the Options Strategy wherein the interface may display:

The trader draws in a line depicting the Strike Price of the Sold Call above a recent high, corresponding to a Strike Price in the current series. (i.e. $11.00).

The following information is provided by the system 1, based on the
a. Historical Volatility (derived from the Historical Price graph)
b. Last Price Trade (Close of last Bar)
c. Last Trade Date (Date of Last Bar)

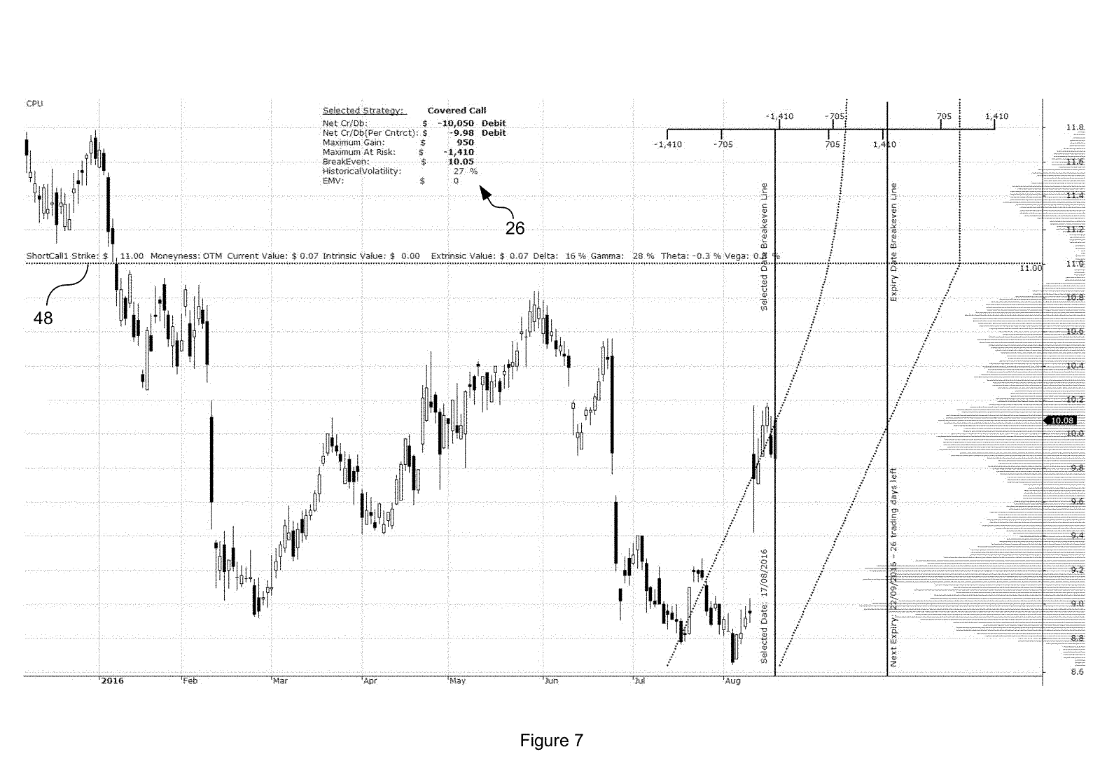

The screen refreshes and updates to that which is shown in FIG. 7.

The Information relating to the Call Option at the selected Strike Price is calculated and displayed 48 in FIG. 14 showing
a. The Call 1 Strike Price
b. The Moneyness of the Option
c. The current value (Theoretical) of the option, Intrinsic and Extrinsic

The Greeks of the Option are displayed showing
a. Delta
b. Gamma
c. Theta
d. Vega

As such, information may be displayed above the interactive strike price line 23 as follows:

The trader enters the (Theoretical) Current Value of the Option, or another value reflecting the current market price of the option into the Call Paid/ Premium Received field of the Parameters pane.

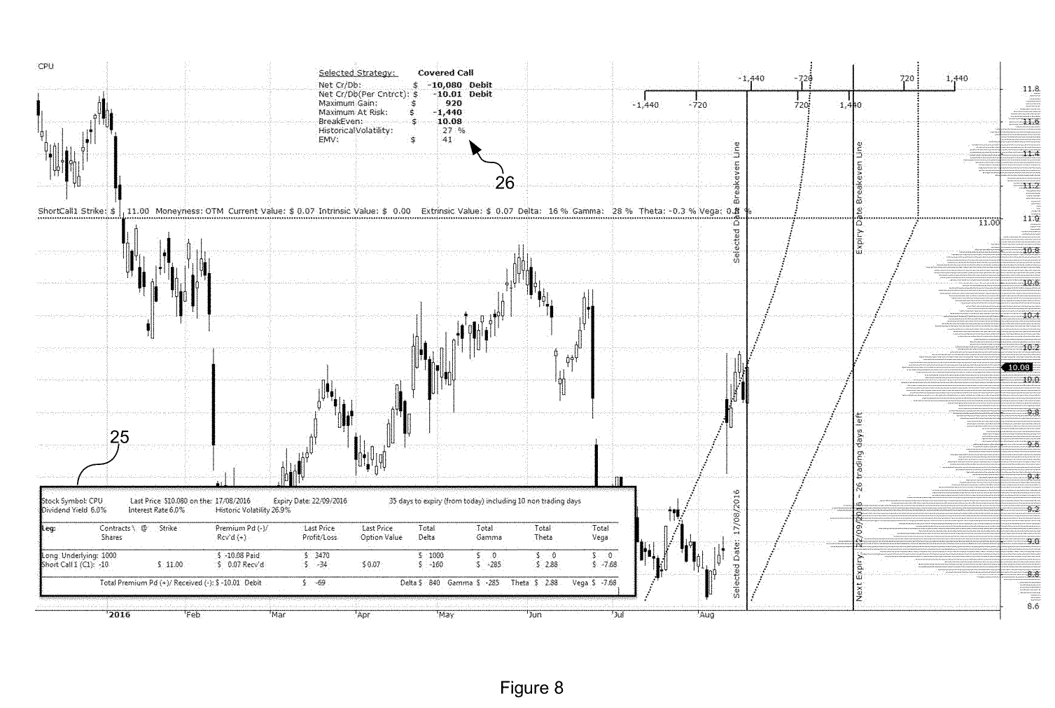

The screen refreshes and updates to that which is shown in FIG. 8.

The Selected Key Strategy Statistics 26 that are updated on the top of the graph in FIG. 8 show:

The trader observes that the Expected Monetary Value of the Strategy is $41.00.

The user has a range of choices that he/she can undertake to modify the parameters of the strategy to derive a more profitable outcome (higher expected monetary value).

Each parameter that is varied updates instantly;

By dragging the strike price for the call option up and down the graph, the following is automatically and instantly updated.
a. The Option Leg Strategy Information
b. The Selected Key Strategy Statistics
c. The expected monetary value
d. The Expiry Date payoff diagram and the Selected Date payoff diagram

The trader can quickly visualise the profitability of the trade by a simple comparison wherein the payoff diagram depicts the profitability of the trade at any price within the visible range vs the volume-at-price profile depicts the probability of the underlying price within the visible range.

Now, the trader seeks a payoff diagram that is the mirror image of the volume-at-price profile, i.e. high probability of a profit, and low probability of a loss.

The trader drags down the strike price 23 to a level of 10.00 to determine the effect on the outcome of the strategy.

The interface 18 updates with the relevant information wherein an expected monetary value of $75 is displayed, an improvement on the $41.

A quick visual check of the payoff diagrams versus the volume-at-price (Probability Profile) indicates there is a higher proportion of the payoff diagram with a positive outcome.

The trader wishes to explore other possibilities.

The trader wished to achieve a better price for the sold call, by waiting until the share price is closer to the nearest high.

The trader may wish to sell near that level, and would like to reduce the possibility of being called away (Assigned), by changing to a 10.25 Strike.

The trader adjusts the strike price 23 to $10.25.

The system 1 updates and indicates that at the last date and last price, the current value of the Call is $0.26.

Using the parameters window of FIG. 6, the trader switches from Last Date/Last Price mode to Selected Date/Target Price.

A Warning is displayed indicating that no Target Price has been drawn.

The trader can view a range of alternatives by exploring the effect on the scenario by changing the price used in the underlying calculations to a price they expect may be achieved.

A target price of 10.20 is drawn.

This returns a value of Option Theoretical Value of 33 cents.

The system 1 updates and reflects an expected monetary value of $123.

The selected date payoff diagram 21C indicates the profitability of the strategy at any date prior to expiry. This is important as many traders do not hold the strategy all the way to the Expiry Date.

The trader wishes to view what the payoff would look like in a weeks' time.

The trader changes the selected date to the 24th of August.

The following updates automatically and are instantly displayed as it depicts the trade information at the Last Date/Selected Date and the Last Price/Target Price.
a. The Selected Date payoff diagram
b. The Individual Leg Information

The following does not change as it depicts the trade information at Expiry.
a. The Key Statistics for the Selected Strategy
b. The expected monetary value

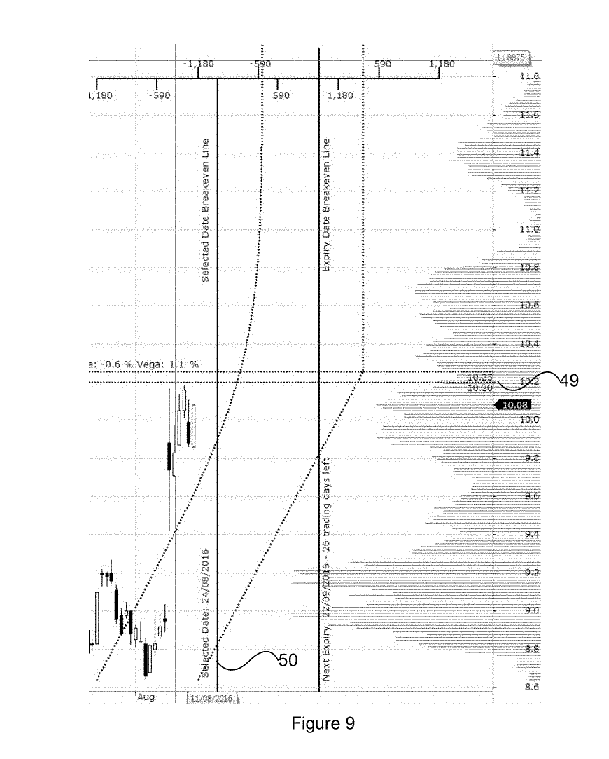

FIG. 9 shows the Selected date payoff diagram of the Covered Call 50 on 24th August, with a target price 49 of $10.20.

The trader now wishes to view the effect on a change in volatility of the trade.

The default setting is the historical volatility, derived from the historical price graph 17 of the underlying instrument.

The trader changes the volatility method from historical volatility to implied volatility.

The trader changes the target price from 10.20 to 9.6.

The trader adjusts the Implied Volatility to 30% (resulting from the sharp price fall).

The current status of the trade is displayed.

The trader wishes to explore the sensitivity of the trade to a larger price range.

The trader can zoom in or out of the graph 17 to depict various time frames. The user can reconcile the look back period (Historical Date range) against the maximum length of the trade (Trade Entry date to Expiry Date)

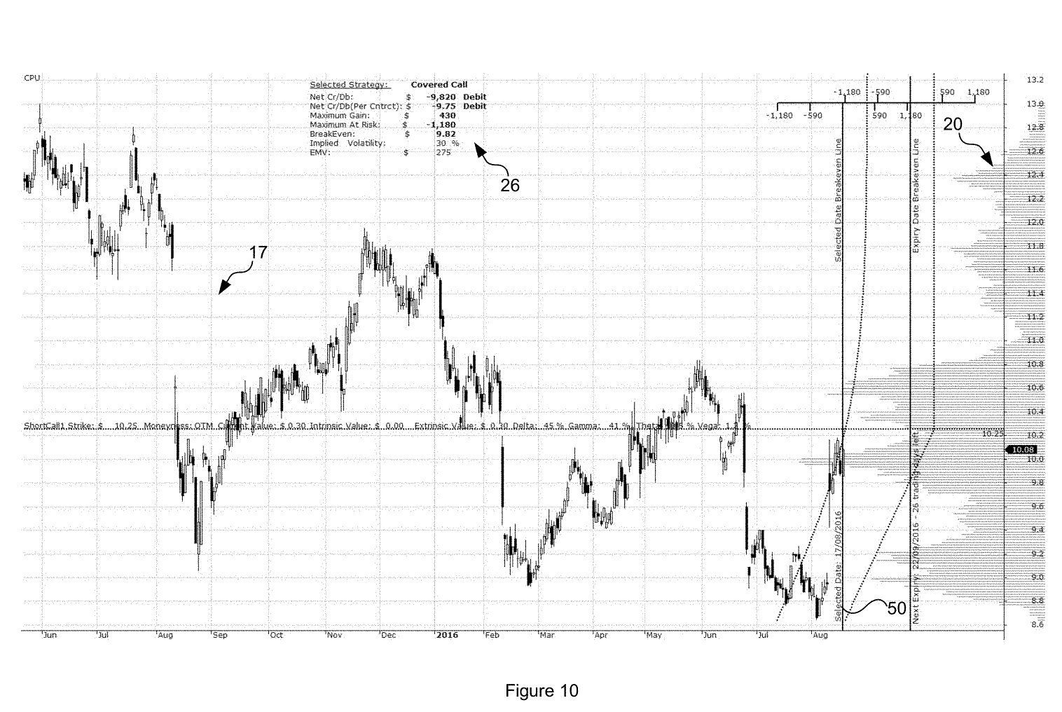

As the time frame is modified, the length of the time displayed on the historical graph 17 is varied, and the resulting volume-at-price graph 20 is accordingly updated. This in turn updates the expected monetary value, derived from the updated Payoff Diagram 50 and the volume-at-price as shown in FIG. 10.

The trader can then weigh up in a quick visual process the appropriate length of look back period on the historic price graph 17 of the underlying instrument, the resulting volume-at-price profile, against the forward looking time period to the expiry date, and test the sensitivity of the trade to various volume-at-price profiles, by way of the expected monetary value (Objective measurement) and a quick visual comparison (Subjective Measurement).

The user compares the possible outcomes of the strategy from the payoff diagrams 21, with probability of the strategy being profitable by a quick visual glance at the price required at expiry.

The probability of any price is indicated by the volume-at-price graph, which indicates that certain prices are more probable than others. This is reconciled with the price momentum of the underlying instrument as indicated by the Historical Price graph.

### Interpretation

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Industrial Applicability

It is apparent from the above, that the arrangements described are applicable to the trading system industries.

1. A system for generating an interactive options trading graphical user interface, the system comprising:
a processor for processing digital data;
a memory device for storing digital data including computer program code, the computer program code comprising a plurality of software modules, the memory device being in operable with the processor and wherein the plurality of software modules comprises:
a graphical user interface rendering module comprising:
a rotated payoff diagram rendering module for rendering an options payoff diagrams; and
an asset price graph rendering module for rendering an asset price graph;
a network interface for receiving data across a data network including historical financial information data from a historical financial information database;
a display device for displaying the options trading graphical user interface wherein the options trading graphical user interface comprises:
the asset price graph having an asset price axis and a time axis showing an asset price characteristic over time, the asset price graph dynamically generated using the historical financial information data; and
an options payoff diagram at an expiry date, the options payoff diagram displayed adjacent to the asset price graph, wherein the options payoff diagram has:
an asset price axis parallel and corresponding to the asset price axis of the asset price graph;
a profitability outcome axis parallel to the time axis of the asset price graph; and
a date/breakeven line aligned with the expiry date on the time axis of the asset price graph.

2. A system as claimed in claim 1, wherein the graphical user interface further comprises:
a further payoff diagram at a selected date, the further options payoff diagram displayed adjacent to the asset price graph, wherein the further options payoff diagram has:
an asset price axis parallel and corresponding to the asset price axis of the asset price graph;
a profitability outcome axis parallel to the time axis of the asset price graph; and
a date/breakeven line aligned with the selected date on the time axis of the asset price graph.

3. A system as claimed in claim 2, wherein the date/breakeven line of the further payoff diagram is interactively positionable to adjust the selected date.

4. A system as claimed in claim 2, wherein the further payoff diagram dynamically updates in accordance with a selected date adjustment.

5. A system as claimed in claim 1, wherein the options trading graphical user interface further comprises an interactive strike price line interactively positionable to adjust a strike price and wherein the options payoff diagram dynamically updates in accordance with a strike price adjustment from the interactive strike price line.

6. A system as claimed in claim 5, wherein option values are displayed adjacent the interactive strike price line and wherein adjusting the position of the interactive strike price line causes the option values to dynamically update accordingly.

7. A system as claimed in claim 1, wherein the options payoff diagram displays an option strategy comprising a plurality of options and wherein the options trading graphical user interface comprises a plurality of interactive strike price lines interactively positionable to adjust a strike price for each of the plurality of options.

8. A system as claimed in claim 7, wherein option values are displayed adjacent each of the plurality of interactive strike price lines.

9. A system as claimed in claim 2, wherein the options trading graphical user interface further comprises an interactive target price line interactively positionable to adjust a target price and wherein the further options payoff diagram dynamically updates in accordance with a target price adjustment.

10. A system as claimed in claim 2, wherein the options trading graphical user interface further comprises an implied volatility input and wherein the further payoff diagram dynamically updates in accordance with an implied volatility adjustment.

11. A system as claimed in claim 2, wherein the options trading graphical user interface further comprises a selected strategy key statistics window displaying selected strategy key statistics and wherein the selected key statistics are configured to dynamically update in accordance with at least one of a strike price adjustment and expiry date adjustment.

12. A system as claimed in claim 2, wherein the options trading graphical user interface further comprises an options leg strategy information window displaying options leg strategy information and wherein the options leg strategy information are configured to dynamically update in accordance with at least one of a strike price adjustment, target price adjustment, selected date adjustment and expiry date adjustment.

13. A system as claimed in claim 1, wherein the options trading graphical user interface further comprises a volume-at-price diagram having an asset price axis parallel and corresponding to the asset price axis of the options payoff diagram, the volume-at-price diagram having a volume-at-price axis.

14. A system as claimed in claim 13, wherein the asset price graph is displayed in accordance with an adjustable date range and wherein the volume-at-price chart updates dynamically in accordance with a date range adjustment of the asset price graph.

15. A system as claimed in claim 14, wherein the plurality of software modules further comprises an expected monetary value calculation module configured for calculating an expected monetary value in accordance with a probability distribution function derived from volume-at-price chart data and possible financial outcomes data derived from the options payoff diagram at an expiry date and wherein the options trading graphical user interface displays the expected monetary value and wherein the expected monetary value dynamically updates in accordance with the date range adjustment of the asset price graph

16. A system as claimed in claim 13, wherein the software modules further comprise an option strategy optimisation module configured for optimising an optimised option strategy and wherein the options payoff diagram displays the optimised option strategy adjacent the volume-at-price diagram.

17. Printed matter comprising an options trading graphical representation comprising:
asset price graph having an asset price axis and a time axis showing an asset price characteristic over time; and
an options payoff diagram at an expiry date, the options payoff diagram displayed adjacent to the asset price graph, wherein the options payoff diagram has:
an asset price axis parallel and corresponding to the asset price axis of the asset price graph;
a profitability outcome axis parallel to the time axis of the asset price graph; and
a date/breakeven line aligned with the expiry date on the time axis.

18. Printed matter as claimed in claim 17, further comprising a further payoff diagram at a selected date, the further options payoff diagram displayed adjacent to the asset price graph, wherein the further options payoff diagram has:
an asset price axis parallel and corresponding to the asset price axis of the asset price graph;
a profitability outcome axis parallel to the time axis of the asset price graph; and
a date/breakeven line aligned with the selected date on the time axis of the asset price graph.

19. Printed matter as claimed in claim 17, further comprising a volume-at-price diagram having an asset price axis parallel and corresponding to the asset price axis of the options payoff diagram, the volume-at-price diagram having a volume-at-price axis.
